(19) United States
(12) Patent Application Publication
(10) Pub. No.: US 2011/0242346 A1
(43) Pub. Date: Oct. 6, 2011

(54) COMPOUND EYE PHOTOGRAPHING METHOD AND APPARATUS

(76) Inventor: Shunta EGO, Kurokawa-gun (JP)

(21) Appl. No.: 13/022,262

(22) Filed: Feb. 7, 2011

(30) Foreign Application Priority Data
Mar. 31, 2010 (JP) 083111/2010

(51) Int. Cl. H04N 5/232; H04N 5/228

(52) U.S. Cl. 348/222.1; 348/348; 348/E05.045; 348/E05.031

(57) ABSTRACT

An object is detected from live view images photographed by two imaging sections, correspondence relationship of the detected object is detected between the two live view images and between previous and current frames, and priority degrees of detected objects are adjusted. A distance from a camera to the object is calculated, and an object movement distance between the frames is calculated from an amount of change of the camera-to-object distance, which change occurs between the frames of the live view images. A focusing position for each of objects of the highest and second highest priority degrees and for each of the next and subsequent frames is predicted from the object movement distance. Photographing is performed by focusing on each of the objects of the highest and second highest priority degrees at each of the two imaging sections in accordance with each of the predicted focusing positions.

### BACKGROUND OF THE INVENTION

1. Field of the Invention

This invention relates to a photographing method with a camera, or the like. This invention particularly relates to a photographing method, wherein automatic focusing is performed on moving objects in anticipation of the movements of the objects.

This invention also relates to a photographing apparatus for carrying out the photographing method described above.

2. Description of the Related Art

Heretofore, there have been proposed various photographing apparatuses, such as cameras, wherein automatic focusing is performed on a moving object in anticipation of an amount of the movement occurring after a distance survey has been made.

For example, in Japanese Unexamined Patent Publication No. 5(1993) -027157, an automatic focus adjusting apparatus is disclosed, wherein a direction of relative movement of an object and a movement speed of the object with respect to a direction of a lens optical axis are calculated in accordance with a defocus amount having been calculated by distance surveying means, and wherein a focus lens is driven in accordance with the results of the calculations up to a focusing position after a predetermined period of time in anticipation of the driving time of focus lens. In Japanese Unexamined Patent Publication No. 5(1993)-027157, it is also described that, in the automatic focus adjusting apparatus provided with the aforesaid basic functions, in cases where a release interruption occurs, the focus lens is driven in anticipation of the amount, in which the object moves during a period of time ranging from a standard point of time after the lens driving to the point of time at which the release interruption occurs.

Also, in Japanese Unexamined Patent Publication No. 7(1995)-199059, an automatic focus adjusting apparatus is disclosed, wherein an amount of image surface movement due to a movement of an object or an amount with respect to an image surface movement speed is measured immediately before two different timings of moment, wherein a judgment as to whether the movement of the object has or has not occurred is made in accordance with a ratio between the amounts having been measured immediately before the two different timings of moment, and wherein, in cases where it has been judged that the movement of the object has occurred, a focus lens is driven in anticipation of the amount of the movement of the object.

However, in cases where object photographing is performed with a camera, or the like, it may often occur that there are two objects (tow main objects), e.g. a person and an animal, on which the focusing is to be performed, and that the two objects are moving in different directions and at different speeds. With each of the automatic focus adjusting apparatuses described in Japanese Unexamined Patent Publication Nos. 5(1993)-027157 and 7(1995)-199059, although it is possible for the photographing to be performed by focusing on a single moving object, it is not always possible for the photographing to be performed by focusing on each of the two objects, which are moving in the manner described above.

### SUMMARY OF THE INVENTION

The primary object of the present invention is to provide a photographing method, wherein photographing is performed by focusing on each of two moving objects.

Another object of the present invention is to provide a photographing apparatus for carrying out the photographing method.

The present invention provides a photographing method constituted as a compound eye photographing method, wherein two imaging sections are used. The compound eye photographing method in accordance with the present invention is characterized by assigning a priority degree to a common object, the correspondence relationship of which is detected between two live view images obtained by the two imaging sections, making prediction calculations of lens focusing positions in anticipation of amounts of object movements and with respect to an object of the highest priority degree and an object of the second highest priority degree, and performing a photographing operation by setting the predicted lens focusing positions respectively at one of the two imaging sections and at the other imaging section, whereby the photographing operation is performed by focusing on each of the two moving objects.

Specifically, the present invention provides a compound eye photographing method, comprising the steps of:

i) imaging two live view images by two imaging sections, each of which is provided with a focus lens,

ii) detecting a predetermined object from the two live view images, which are outputted respectively by the two imaging sections,

iii) detecting correspondence relationship of the detected object between the two live view images and between a previous frame and a current frame of the live view images,

iv) adjusting priority degrees of objects in cases where a plurality of the objects have been detected,

v) calculating a distance from a camera to the detected object,

vi) calculating an object movement distance between the frames of the live view images, the calculation being made in accordance with an amount of change of the camera-to-object distance, which change occurs between the frames of the live view images,

vii) predicting a focusing position with respect to the object, which focusing position is to be taken for each of the next frame and frames that follow, the prediction being performed in accordance with the calculated object movement distance, and

viii) performing the prediction of the focusing position with respect to each of an object of the highest priority degree and an object of the second highest priority degree in cases where the plurality of the objects have been detected,

whereby a photographing operation is performed by focusing on each of the object of the highest priority degree and the object of the second highest priority degree at each of the two imaging sections in accordance with each of the predicted focusing positions.

In cases where the photographing method described above is performed by the provision of three of more imaging sections, the photographing operation may be performed by focusing on each of three or more moving objects. In such cases, if two certain imaging sections and the processes relevant to the two certain imaging sections are taken into consideration, the aforesaid photographing method performed by the provision of the three of more imaging sections will become identical with the photographing method in accordance with the present invention and is therefore embraced in the scope of the compound eye photographing method in accordance with the present invention.

The present invention also provides a compound eye photographing apparatus for carrying out the compound eye photographing method in accordance with the present invention. Specifically, the present invention also provides a compound eye photographing apparatus, comprising:

i) two imaging sections, each of which is provided with a focus lens,

ii) an object detecting section for detecting a predetermined object from two live view images, which are outputted respectively by the two imaging sections,

iii) an object correspondence detecting section for detecting correspondence relationship of the detected object between the two live view images and between a previous frame and a current frame of the live view images,

iv) a priority degree adjusting section for adjusting priority degrees of objects in cases where a plurality of the objects have been detected,

v) a distance calculating section for calculating a distance from a camera to the detected object,

vi) a movement distance calculating section for calculating an object movement distance between the frames of the live view images, the calculation being made in accordance with an amount of change of the camera-to-object distance, which change occurs between the frames of the live view images, and

vii) a focusing position predicting section for predicting a focusing position with respect to the object, which focusing position is to be taken for each of the next frame and frames that follow, the prediction being performed in accordance with the calculated object movement distance,

the prediction of the focusing position being performed with respect to each of an object of the highest priority degree and an object of the second highest priority degree in cases where the plurality of the objects have been detected by the object detecting section,

whereby a photographing operation is performed by focusing on each of the object of the highest priority degree and the object of the second highest priority degree at each of the two imaging sections in accordance with each of the predicted focusing positions.

In cases where the constitution described above is employed by the provision of three of more imaging sections, the photographing operation may be performed by focusing on each of three or more moving objects. In such cases, if two certain imaging sections and the constitutions relevant to the two certain imaging sections are taken into consideration, the aforesaid photographing apparatus employed by the provision of the three of more imaging sections will become identical with the photographing apparatus in accordance with the present invention and is therefore embraced in the scope of the compound eye photographing apparatus in accordance with the present invention.

The compound eye photographing apparatus in accordance with the present invention should preferably be modified such that the apparatus receives a priority degree update operation performed by an apparatus user and performs priority degree update processing for readjusting the priority degrees of the objects.

Also, the compound eye photographing apparatus in accordance with the present invention should preferably be modified such that the apparatus performs priority degree update processing for readjusting the priority degrees of the objects at the time of every variation of the frame of the live view images.

Further, the compound eye photographing apparatus in accordance with the present invention should preferably be modified such that the objects acting as targets of the focusing are previously registered in registering means,

the objects having been registered in the registering means are recognized at the time of the detection of the objects in the live view images, and

the thus recognized objects having been registered in the registering means are taken as the detected objects.

In such cases, the compound eye photographing apparatus in accordance with the present invention should more preferably be modified such that the objects inputted by a user are taken as the objects to be registered.

Furthermore, the compound eye photographing apparatus in accordance with the present invention should preferably be modified such that a judgment is made as to whether the predicted focusing position is or is not close to a limit of a photographable range, and

photographing processing is performed in cases where it has been judged that the predicted focusing position is close to the limit of the photographable range, the photographing processing being performed even though the photographing processing by a user is not performed.

Also, the compound eye photographing apparatus in accordance with the present invention should preferably be modified such that the object movement is detected in accordance with the calculated object movement distance, and

an object, the movement of which is not detected, is excluded from a target of the focusing.

With the compound eye photographing apparatus in accordance with the present invention, the priority degree is assigned to the common object, the correspondence relationship of which is detected between the two live view images obtained by the two imaging sections, and the prediction calculations are made to find the lens focusing positions in anticipation of the amounts of the object movements and with respect to the object of the highest priority degree and the object of the second highest priority degree. Also, the photographing operation is performed by setting the predicted lens focusing positions respectively at one of the two imaging sections and at the other imaging section, and the photographing operation is thus performed by focusing on each of the two moving objects.

The compound eye photographing apparatus in accordance with the present invention may be modified such that the apparatus receives the priority degree update operation performed by the apparatus user and performs the priority degree update processing for readjusting the priority degrees of the objects. With the modification described above, in cases where objects, which are not intended originally by the user, are taken as the focusing targets, the priority degree update processing may be performed by the user, and thereafter the objects as intended by the user are set as the focusing targets.

In cases where the same objects are imaged successively in the live view images, if the same objects are moving, the composition in each frame will vary, and therefore there will be the possibility that the priority degrees having already been adjusted will not be adapted to the composition of the current frame. Therefore, the compound eye photographing apparatus in accordance with the present invention may be modified such that the apparatus performs the priority degree update processing for readjusting the priority degrees of the objects at the time of every variation of the frame of the live view images. With the modification described above, the photographing operation is performed by reliably focusing on the two objects which are most adapted to the priority degree adjusting conditions. Also, in cases where the original priority degree calculations have been made by mistake, the priority degree update processing may be performed, and the correct priority degrees are thus assigned to the objects.

Further, the compound eye photographing apparatus in accordance with the present invention may be modified such that the objects acting as targets of the focusing are previously registered in the registering means, the objects having been registered in the registering means are recognized at the time of the detection of the objects in the live view images, and the thus recognized objects having been registered in the registering means are taken as the detected objects. With the modification described above, the effects described below are obtained. Specifically, with the modification described above, in cases where the images of many objects, such as persons, are present in the live view images, the photographing operation is performed by eliminating unnecessary objects and by focusing on only the objects, which the user desires to photograph. Also, since the unnecessary objects are eliminated, the amount of the processing becomes small, and the focusing processing is performed quickly.

In such cases, the compound eye photographing apparatus in accordance with the present invention may be modified such that the objects inputted by the user are taken as the objects to be registered. With the modification described above, the level of probability that the photographing operation will be performed by focusing on the objects, which the user desires to photograph, is enhanced.

Furthermore, the compound eye photographing apparatus in accordance with the present invention may be modified such that the judgment is made as to whether the predicted focusing position is or is not close to the limit of the photographable range, and the photographing processing is performed in cases where it has been judged that the predicted focusing position is close to the limit of the photographable range, the photographing processing being performed even though the photographing processing by the user is not performed. With the modification described above, the photographing operation is performed reliably without a timing appropriate for the photographing of the moving objects being lost.

Also, the compound eye photographing apparatus in accordance with the present invention may be modified such that the object movement is detected in accordance with the calculated object movement distance, and the object, the movement of which is not detected, is excluded from the target of the focusing. With the modification described above, the focusing on the object which is not moving is avoided, and therefore the level of probability that the photographing operation will be performed by focusing on the objects, such as persons, on which the focusing is to be performed, is enhanced.

The compound eye photographing method in accordance with the present invention is carried out appropriately by the compound eye photographing apparatus in accordance with the present invention, which comprises the two imaging sections, the object detecting section, the object correspondence detecting section, the priority degree adjusting section, the distance calculating section, the movement distance calculating section, and the focusing position predicting section.

Further, the compound eye photographing apparatus in accordance with the present invention may be modified such that the apparatus further comprises a registering section for registering predetermined objects as the objects to be detected, and an object recognizing section for recognizing an object, which has been registered in the registering section, from the live view images outputted by the imaging sections and thus acting as the object detecting section. With the modification described above, incases where the images of many objects, such as persons, are present in the live view images, the photographing operation is performed by eliminating unnecessary objects and by focusing on only the objects, which the user desires to photograph. Also, since the unnecessary objects are eliminated, the amount of the processing becomes small, and the focusing processing is performed quickly.

### BRIEF DESCRIPTION OF THE DRAWINGS

FIG. 1 is a front perspective view showing external constitution of an embodiment of the compound eye photographing apparatus in accordance with the present invention,

FIG. 2 is a back perspective view showing external constitution of the embodiment of the compound eye photographing apparatus in accordance with the present invention,

FIG. 3 is a block diagram showing electric constitution of the embodiment of the compound eye photographing apparatus in accordance with the present invention,

FIG. 4A is a flow chart showing a flow of photographing processing in a first embodiment of the compound eye photographing method carried out in the compound eye photographing apparatus in accordance with the present invention,

FIG. 4B is a flow chart showing a flow of photographing processing in the first embodiment of the compound eye photographing method carried out in the compound eye photographing apparatus in accordance with the present invention,

FIG. 5 is an explanatory view showing an example of a state of location of objects (main objects),

FIG. 6 is an explanatory view showing a different example of a state of location of the objects,

FIG. 7A is a flow chart showing a flow of processing in a second embodiment of the compound eye photographing method in accordance with the present invention,

FIG. 7B is a flow chart showing a flow of processing in a second embodiment of the compound eye photographing method in accordance with the present invention,

FIG. 8A is a flow chart showing a flow of processing in a third embodiment of the compound eye photographing method in accordance with the present invention,

FIG. 8B is a flow chart showing a flow of processing in the third embodiment of the compound eye photographing method in accordance with the present invention,

FIG. 9A is a flow chart showing a flow of processing in a fourth embodiment of the compound eye photographing method in accordance with the present invention,

FIG. 9B is a flow chart showing a flow of processing in the fourth embodiment of the compound eye photographing method in accordance with the present invention,

FIG. 10 is a block diagram showing electric constitution of a different embodiment of the compound eye photographing apparatus in accordance with the present invention,

FIG. 11 is a flow chart showing a flow of a part of processing in a fifth embodiment of the compound eye photographing method in the compound eye photographing apparatus of FIG. 10,

FIG. 12A is a flow chart showing a flow of processing in a sixth embodiment of the compound eye photographing method in accordance with the present invention,

FIG. 12B is a flow chart showing a flow of processing in the sixth embodiment of the compound eye photographing method in accordance with the present invention,

FIG. 13 is an explanatory view showing a further different example of a state of location of objects,

FIG. 14 is an explanatory view showing a still further different example of a state of location of the objects,

FIG. 15A is a flow chart showing a flow of processing in a seventh embodiment of the compound eye photographing method in accordance with the present invention,

FIG. 15B is a flow chart showing a flow of processing in the seventh embodiment of the compound eye photographing method in accordance with the present invention,

FIG. 16 is an explanatory view showing a further different example of a state of location of objects, and

FIG. 17 is an explanatory view showing a still further different example of a state of location of the objects.

### DESCRIPTION OF THE PREFERRED EMBODIMENTS

The present invention will hereinbelow be described in further detail with reference to the accompanying drawings.

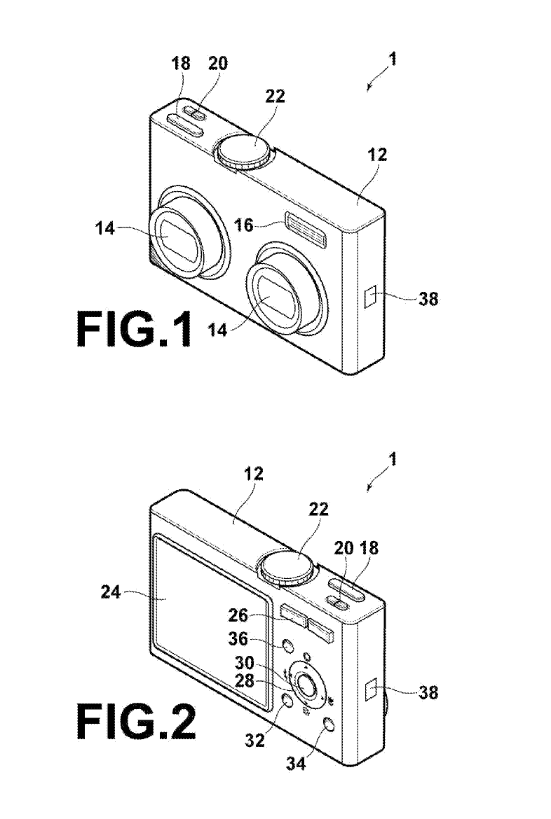

FIG. 1 is a front perspective view showing external constitution of a digital camera 1, which is an embodiment of the compound eye photographing apparatus in accordance with the present invention. FIG. 2 is a back perspective view showing external constitution of the digital camera 1. As will be described later, the digital camera 1 has the functions for photographing and recording 3D images. However, the compound eye photographing apparatus in accordance with the present invention need not necessarily be provided with the functions for photographing and recording the 3D images.

As illustrated in FIG. 1, a camera body 12 of the digital camera 1 is formed in a rectangular box-like shape. Two taking lenses 14, 14, a flash (strobe) 16, and the like, are located at a front face of the camera body 12. Also, a shutter button 18, a power supply/mode switch 20, a mode dial 22, and the like, are located at a top face of the camera body 12.

Further, as illustrated in FIG. 2, a monitor 24, a zoom button 26, a cross button 28, a MENU/OK button 30, a DISP button 32, a BACK button 34, a macro button 36, and the like, are located at a back face of the camera body 12. Furthermore, an input/output connector 38 is located at a side face of the camera body 12.

Also, though not shown in FIG. 1 and FIG. 2, a tripod screw hole, a battery cover which can be opened and closed freely, and the like, are located at a bottom face of the camera body 12. Further, a battery storage chamber for storing a battery, a memory card slot for mounting a memory card, and the like, are located inside the battery cover.

One of the taking lenses 14, 14 constitutes a part of a right imaging system, which will be described later, and the other taking lens 14 constitutes a part of a left imaging system, which will be described later. Each of the taking lenses 14, 14 is constituted of a collapsible mount type zoom lens. When a power supply of the digital camera 1 is turned ON, the taking lenses 14, 14 protrude from the camera body 12. A zoom mechanism, a collapsible mount mechanism, and a focusing mechanism of each of the taking lenses 14, 14 are constituted of known mechanisms and are herein not explained in detail. The flash 16 is constituted of a xenon tube and is fired, when necessary, in the cases of the photographing of a dark object, a backlit object, or the like.

The shutter button 18 is constituted of a two-stage stroke type switch, which performs different functions in the state of the so-called “half press” and in the state of the so-called “full press.” In cases where the shutter button 18 is pressed halfway at the time of a still picture photographing operation with a still picture photographing mode being selected by the mode dial 22 or with the still picture photographing mode being selected from a menu, the digital camera 1 performs photographing preparation processing, i.e. an AE (automatic exposure) process, an AF (auto focus) process, and an AWB (automatic white balance) process. In cases where the shutter button 18 is then pressed fully, the digital camera 1 performs the image photographing and recording processing. When necessary, the digital camera 1 may be imparted with a motion picture photographing functions. However, the motion picture photographing functions do not have a direct relationship with the present invention and are herein not explained in detail.

The power supply/mode switch 20 functions as a power supply switch of the digital camera 1 and as switching means for switching between a playback mode and a photographing mode of the digital camera 1. The power supply/mode switch 20 is formed so as to slide to each of an “OFF” position, a “playback” position, and a “photographing” position. In cases where the power supply/mode switch 20 is set at the “playback” position, the digital camera 1 is set in the playback mode. In cases where the power supply/mode switch 20 is set at the “photographing” position, the digital camera 1 is set in the photographing mode. In cases where the power supply/mode switch 20 is set at the “OFF” position, the power supply is turned OFF.

The mode dial 22 is used for setting various modes of the photographing mode. The mode dial 22 is rotatably located at the top face of the camera body 12. By a click mechanism (not shown), by way of example, the mode dial 22 is set at each of a “2D still picture” position, a “2D motion picture” position, a “3D still picture” position, a “3D motion picture” position, and a “2 objects tracking” position. In cases where the mode dial 22 is set at the “2D still picture” position, the digital camera 1 is set in a 2D still picture photographing mode for photographing a 2D still picture, i.e. an ordinary 2-dimensional still picture, and a flag, which represents that the 2D mode is selected, is set at a 2D/3D mode switching flag (not shown). Also, in cases where the mode dial 22 is set at the “2D motion picture” position, the digital camera 1 is set in a 2D motion picture photographing mode for photographing a 2D motion picture, and a flag, which represents that the 2D mode is selected, is set at the 2D/3D mode switching flag described above.

In cases where the mode dial 22 is set at the “3D still picture” position, the digital camera 1 is set in a 3D still picture photographing mode for photographing a 3D still picture, i.e. a 3-dimensional still picture, and a flag, which represents that the 3D mode is selected, is set at the 2D/3D mode switching flag described above. Also, in cases where the mode dial 22 is set at the “3D motion picture” position, the digital camera 1 is set in a 3D motion picture photographing mode for photographing a 3D motion picture, and a flag, which represents that the 3D mode is selected, is set at the 2D/3D mode switching flag described above.

A CPU 110, which will be described later, makes reference to the 2D/3D mode switching flag and detects whether the 2D mode or the 3D mode is selected. Each of the 3D still picture photographing mode and the 3D motion picture photographing mode is the mode, in which two kinds of the images having parallax with each other are photographed by the right imaging system comprising one of the taking lenses 14, 14 and the left imaging system comprising the other taking lens 14. In the aforesaid mode, distance information is calculated in accordance with the parallax with respect to correspondence points in the two kinds of the images. The distance information is utilized for displaying or recording a stereo picture (3-dimensional image). The displaying or recording of the stereo picture is herein not explained in detail.

The monitor 24 is constituted of image display means, such as a color liquid crystal panel. The monitor 24 is utilized as a image display section for displaying a photographed image. Also, at the time of various setups, the monitor 24 is utilized as a GUI. Further, at the time of the photographing operation, live view images that are photographed successively by an image sensor 134, which will be described later, are displayed on the monitor 24, and the monitor 24 is thus utilized as an electronic finder.

The zoom button 26 is used for altering the zoom magnifying power of the taking lenses 14, 14. The zoom button 26 is constituted of a tele-zoom button, which instructs a zoom to a telephoto side, and a wide-zoom button, which instructs a zoom to a wide-angle side.

The cross button 28 is formed for pressing in four directions of up, down, left, and right directions. A function in accordance with a setting state of the camera is assigned to the button in each direction. For example, at the time of the photographing operation, a function of switching ON/OFF of a macro function is assigned to the left button, and a function of switching a flash mode is assigned to the right button. Also, a function of changing brightness of the monitor 24 is assigned to the up button. Further, a function of switching ON/OFF of a self-timer is assigned to the down button.

Furthermore, at the time of playback, a function of frame advance is assigned to the left button, and a function of frame back is assigned to the right button. Also, the function of changing the brightness of the monitor 24 is assigned to the up button, and a function of deleting an image during playback is assigned to the down button. Also, at the time of various setups, functions of moving a cursor displayed on the monitor 24 toward the directions of the respective buttons are assigned to the respective buttons.

The MENU/OK button 30 is used for a call of a menu screen (MENU function). The MENU/OK button 30 is also used for decision of a selected item, instruction of process execution, and the like (OK function). The assigned functions are changed over in accordance with the setting state of the digital camera 1. On the aforesaid menu screen, setups of all the adjustment items which the digital camera 1 has are performed. Examples of the adjustment items include an exposure value, a tint, an ISO speed, image quality adjustment, such as a number of recording pixels, a setup of self-timer, switching of a photometry system, and use/nonuse of digital zoom. The digital camera 1 operates in accordance with the condition having been set on the menu screen.

The DISP button 32 is used for inputting an instruction for switching of the displayed content of the monitor 24, and the like. The BACK button 34 is used for inputting an instruction of cancellation of the input operation, and the like.

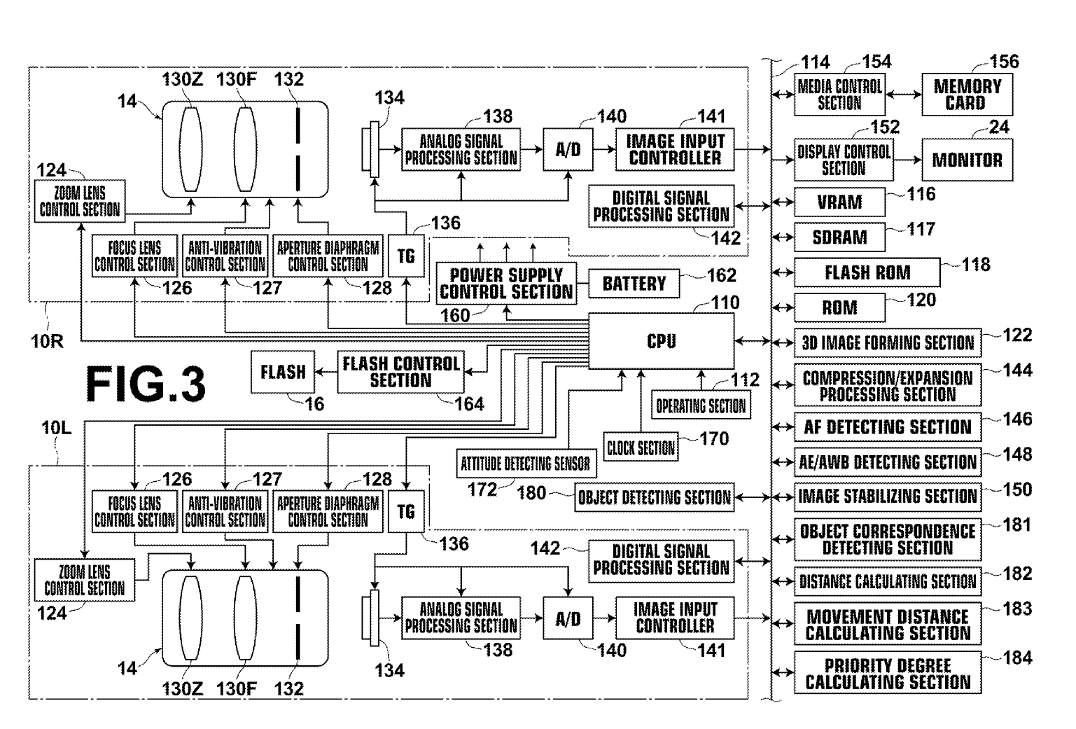

FIG. 3 is a block diagram showing main electric constitution of the digital camera 1. The electric constitution of the digital camera 1 will hereinbelow be described with reference to FIG. 3. The elements, which are shown in FIG. 1 and FIG. 2 and which it is necessary to explain in association with other elements, will also be explained hereinbelow.

As illustrated in FIG. 3, the digital camera 1 is provided with a CPU 110 and an operating section 112 connected to the CPU 110 (comprising the shutter button 18, the power supply/mode switch 20, the mode dial 22, the zoom button 26, the cross button 28, the MENU/OK button 30, the DISP button 32, the BACK button 34, the macro button 36, and the like, described above). The digital camera 1 is also provided with a bus 114, a VRAM 116, an SDRAM 117, a flash ROM 118, a ROM 120, a 3D image forming section 122, a compression/expansion processing section 144, an AF detecting section 146, an AE/AWB detecting section 148, an image stabilizing section 150, a display control section 152, and a media control section 154. The aforesaid elements 116 to 154 are connected via the bus 114 to the CPU 110. The aforesaid monitor 24 is connected to the display control section 152. A memory card 156 acting as a recording media is connected to the media control section 154. Also, a clock section 170 for inputting clock information and an attitude detecting sensor 172 for detecting the attitude of the camera are connected to the CPU 110.

Further, the digital camera 1 is provided with a constitution for automatically focusing on the object in anticipation of the movement of the object. The constitution for automatically focusing on the object comprises an object detecting section 180, an object correspondence detecting section 181, a distance calculating section 182, a movement distance calculating section 183, and a priority degree calculating section 184. The aforesaid elements 180 to 184 are connected via the bus 114 to the CPU 110.

Further, the digital camera 1 is provided with a right imaging system 10R and a left imaging system 10L. The right imaging system 10R and the left imaging system 10L has a basically identical constitution. Each of the right imaging system 10R and the left imaging system 10L comprises the taking lens 14, a zoom lens control section 124, a focus lens control section 126, an anti-vibration control section 127 for controlling the driving of an anti-vibration section (not show), an aperture diaphragm control section 128, an image sensor 134, a timing generator (TG) 136, an analog signal processing section 138, an A/D converter 140, an image input controller 141, and a digital signal processing section 142.

The CPU 110 functions as control means for performing integrated control of operations of the entire camera and controls each section in accordance with a predetermined control program on the basis of an input from the operating section 112. The ROM 120 connected via the bus 114 to the CPU 110 stores a control program, which is executed by the CPU 110, and various kinds of data necessary for the control (AE/AF control data, which will be described later, and the like). The flash ROM 118 stores various pieces of setup information with respect to the operations of the digital camera 1, such as the user setup information.

The SDRAM 117 is used as a calculation work area of the CPU 110 and as a temporary storage area for image data. The VRAM 116 is used as a temporary storage area for exclusive use for image data for display.

Each of the taking lenses 14, 14 is constituted of a zoom lens 130Z, a focus lens 130F, and an aperture diaphragm 132. The zoom lens 130Z is driven by a zoom actuator (not shown) and moves back and forth along an optical axis. The CPU 110 controls the driving of the zoom actuator via the zoom lens control section 124 and thereby controls the position of the zoom lens 130Z. The CPU 110 thus controls the zooming of the taking lens 14, i.e. the operation for altering the zoom magnifying power.

The focus lens 130F is driven by a focus actuator (not shown) and moves back and forth along an optical axis. The CPU 110 controls the driving of the focus actuator via the focus lens control section 126 and thereby controls the position of the focus lens 130F. The CPU 110 thus controls the focusing of the taking lens 14, i.e. the focusing operation.

The aperture diaphragm 132 is driven by an aperture diaphragm actuator (not shown). The CPU 110 controls the driving of the aperture diaphragm actuator via the aperture diaphragm control section 128 and thereby controls an opening amount (f-stop number) of the aperture diaphragm 132. The CPU 110 thus controls the quantity of light incident upon the image sensor 134.

The image sensor 134 is constituted of a color CCD image sensor having a predetermined color filter array. The CCD image sensor is provided with a plurality of photodiodes, which are arrayed in two dimensions at a light receiving surface. An optical image of the object, which image is formed on the light receiving surface of the CCD image sensor by the taking lens 14, is converted by the photodiodes into signal electric charges in accordance with the quantity of the incident light. The signal electric charges stored in the respective photodiodes are sequentially read out in accordance with driving pulses, which are given from the TG 136 in accordance with a command of the CPU 110. A voltage signal (image signal) in accordance with the signal electric charges is thus obtained. The image sensor 134 has the function of the so-called “electronic shutter,” and the exposure time (shutter speed) is controlled by the control of the electric charge storage time into the photodiodes.

In this embodiment, for the displaying of the live view image on the monitor 24 and for the utilization for the automatic focusing, the aforesaid image signal is outputted successively, for example, after power supply/mode switch 20 has been turned ON. In this embodiment, although the CCD image sensor is used as the image sensor 134, it is also possible to use an image sensor having a different constitution, such as a CMOS image sensor.

The analog signal processing section 138 comprises a correlative double sampling circuit (CDS) for removing reset noise (low frequency) contained in the image signal outputted from the image sensor 134. The analog signal processing section 138 comprises an AGS circuit for amplifying the image signal and controlling the image signal at a predetermined level. The analog signal processing section 138 thus amplifies the image signal outputted from the image sensor 134.

The A/D converter 140 converts the analog image signal, which has been outputted from the analog signal processing section 138, into a digital image signal. The image input controller 141 fetches the image signal having been outputted from the A/D converter 140 and stores the image signal in the SDRAM 117.

The digital signal processing section 142 fetches the image signal, which has been stored in the SDRAM 117, in accordance with a command given from the CPU 110. The digital signal processing section 142 performs predetermined signal processing on the image signal and forms a YUV signal, which is constituted of a luminance signal Y and color difference signals Cr and Cb. Also, the digital signal processing section 142 performs processing for fetching an integrated value, which has been calculated by the AE/AWB detecting section 148, and calculating a gain value for white balance adjustment. Further, the digital signal processing section 142 performs offset processing on an image signal of each color of R, G, and B having been fetched via the image input controller 141. Furthermore, the digital signal processing section 142 performs gamma correction processing, noise suppressing processing, and the like.

The AF detecting section 146 receives the image signal of each color of R, G, and B having been fetched from the image input controller 141, calculates a focal point evaluated value necessary for AF control, and outputs the information representing the focal point evaluated value to the CPU 110. At the time of the AF control, the CPU 110 searches a position, which is associated with a maximum of the focal point evaluated value. Also, the CPU 110 moves the focus lens 130F to the thus searched position, and thereby performs the focusing on the main object.

The AE/AWB detecting section 148 fetches the image signal of each color of R, G, and B having been fetched from the image input controller 141 and calculates an integrated value necessary for each of AE control and AWB control. At the time of the AE control, the CPU 110 acquires information representing the integrated value of the image signal of each color of R, G, and B with respect to each area in a field, which integrated value has been calculated by the AE/AWB detecting section 148. The CPU 110 then calculates brightness (photometric value) of the object and performs an exposure setup for obtaining an appropriate exposure amount, i.e. the setups of the sensitivity, the f-stop number, the shutter speed, and whether flash firing is or is not necessary.

Also, at the time of the AWB control, the CPU 110 inputs the information representing the integrated value of the image signal of each color of R, G, and B with respect to each area in a field, which integrated value has been calculated by the AE/AWB detecting section 148, into the digital signal processing section 142 for use in white balance adjustment and detection of a light source type.

The compression/expansion processing section 144 performs compression processing of a predetermined type on the inputted image data in accordance with a command given from the CPU 110 and thereby forms compressed image data. Also, the compression/expansion processing section 144 performs expansion processing of a predetermined type on the inputted compressed image data in accordance with a command given from the CPU 110 and thereby forms uncompressed image data.

The display control section 152 controls the displaying on the monitor 24 in accordance with a command given from the CPU 110. Specifically, in accordance with the command given from the CPU 110, the display control section 152 converts the inputted image signal into a video signal (e.g., an NTSC signal, a PAL signal, or an SCAM signal) for the displaying on the monitor 24 and outputs predetermined letter information and figure information to the monitor 24.

The media control section 154 controls data reading/writing with respect to the memory card 156 in accordance with a command given from the CPU 110.

A power supply control section 160 controls supply of electric power from a battery 162 to various sections in accordance with a command given from the CPU 110. A flash control section 164 controls the firing of the flash 16 in accordance with a command given from the CPU 110.

In cases where the object is photographed with an identical magnifying power with the right imaging system 10R and the left imaging system 10L of the digital camera 1, the images having parallax with each other are photographed by the two imaging systems. By the utilization of the digital image signals representing the aforesaid images, for example, a stereo picture may be constructed, and 3-dimensional position information of the object acting as the measurement target may be acquired. The processing for the purposes described above is performed by the 3D image forming section 122. The processing for the purposes described above does not have a direct relationship with the present invention and is herein not explained in detail.

The respective elements, which are represented as the sections and the like and are connected to the bus 114, may be constituted in the form of independent circuits. Alternatively, the respective elements may be constituted of software functions operating in accordance with predetermined computer programs in a computer system comprising the CPU 110.

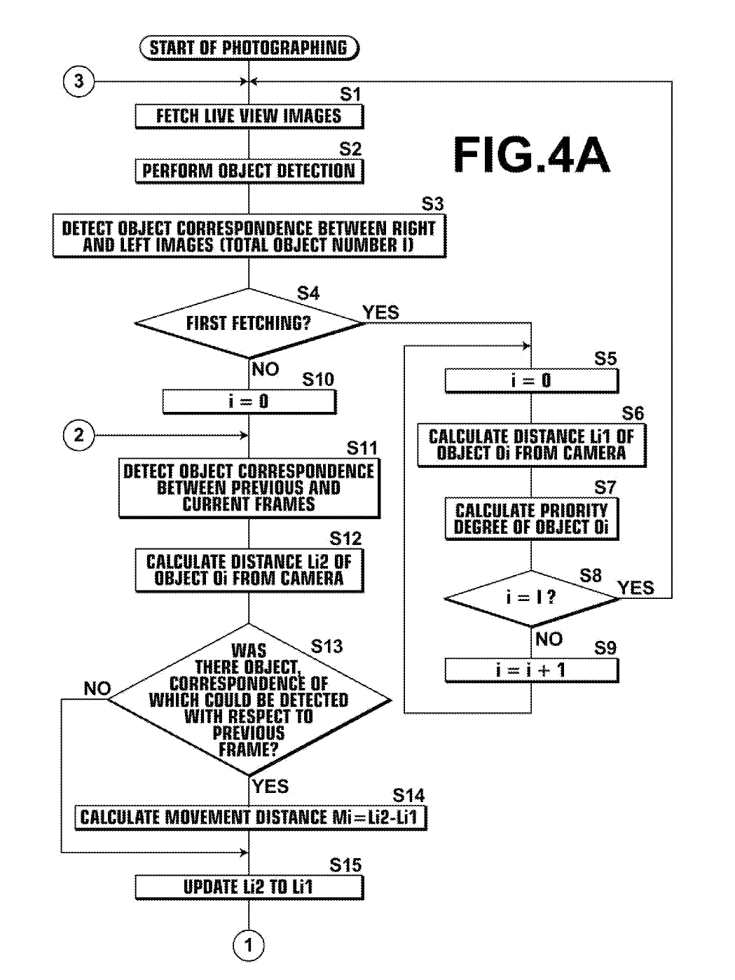

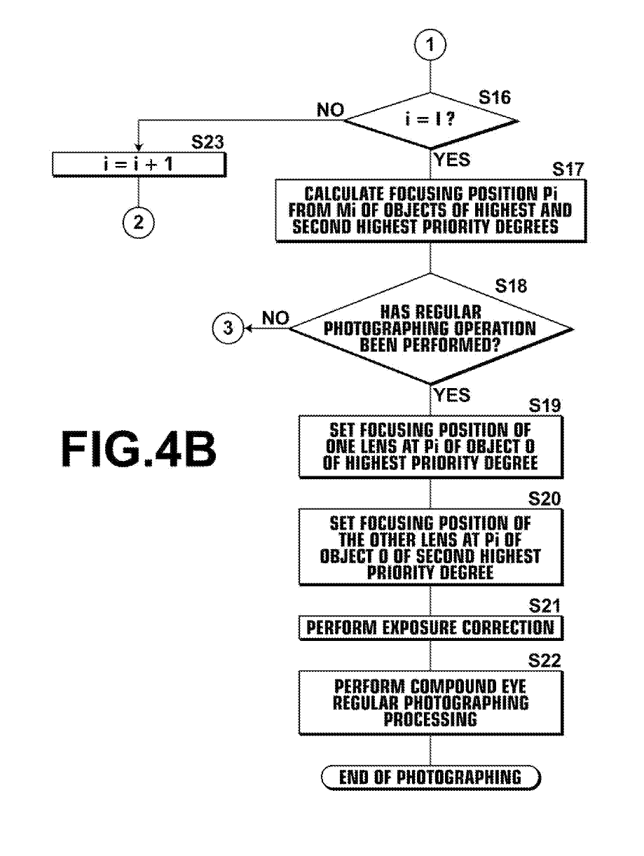

FIGS. 4A and 4B are flow charts showing a flow of photographing processing in a first embodiment of the compound eye photographing method carried out in the digital camera 1. The flow of the processing with respect to the compound eye photographing operation, which is performed with the digital camera 1 by automatically focusing on each of two objects, will be described hereinbelow with reference to FIGS. 4A and 4B. In the explanation made hereinbelow, unless otherwise specified, the processing performed automatically is performed basically in accordance with the control of the CPU 110.

In this case, the aforesaid mode dial 22 is set at the “2 objects tracking” position, the shutter button 18 is pressed halfway, and the photographing operation is begun. In a step S1, the CPU 110 performs the processing for fetching the live view images, i.e. the processing for fetching the images signals, which are successively outputted in units of a frame from the right imaging system 10R and the left imaging system 10L, and temporarily storing the image signals in the SDRAM 117. In the “2 objects tracking” mode, the ordinary AF processing described above is not performed.

Thereafter, in a step S2, the object detecting section 180 detects the object (main object), such as a face of a person or a face of an animal), from the left live view image, i.e. the live view image having been photographed by the left imaging system 10L, and the right live view image, i.e. the live view image having been photographed by the right imaging system 10R. Also, in a step S3, the object correspondence detecting section 181 detects correspondence relationship of the detected object between the right and left live view images. At this time, an object, the correspondence relationship of which has not been detected between the right and left live view images, i.e. the object having been detected from only the right live view image or only the left live view image, is ignored. Only the object, the correspondence relationship of which has been detected between the right and left live view images, is selected and subjected to the processing described below. The total number of the objects having thus been selected is represented by I.

Thereafter, in a step S4, a judgment is made as to whether the fetching of the live view images is or is not a first fetching. In cases where it has been judged that the fetching is the first fetching, in a step S5, a variable i, which sequentially represents a plurality of objects, is set to be 0 (zero). Also, in a step S6, the distance calculating section 182 calculates a distance Li1 of an object Oi from the taking lens 14. By way of example, the distance is calculated in accordance with the parallax between the right and left live view images.

Thereafter, in a step S7, the priority degree calculating section 184 calculates the priority degree of the object Oi. Byway of example, the priority degree is calculated in accordance with a predetermined criterion, such that a high priority degree is assigned as the object position represented by coordinates on the image becomes close to a center point of the image, or as the object area becomes large.

Thereafter, in a step S8, a judgment is made as to whether or not i=I. In cases where it has been judged that i≠I, in a step S9, the value of i is increased by “1.” Thereafter, the processing in the step S6 and those that follow is iterated. In cases where it has been judged in the step S8 that i=I, the processing flow is returned to the step S1. In this manner, at the time at which the live view images are fetched for the first time, the distance from the camera and priority degree are calculated with respect to each of the “I” number of the objects.

In cases where a second fetching of the live view images is performed, the same processing as the processing in the step S2 to the step S4 is performed. In cases where it has been judged in the step S4 that the fetching of the live view images is not the first fetching, in a step S10, the value of the variable i as described above is set to be 0 (zero). Thereafter, in a step S11, the object correspondence detecting section 181 detects the object correspondence relationship between the current frame and a previous frame. In this case, basically, the term “previous frame” represents the frame of the period previous by one to the “current frame.”However, for the reasons of a processing speed, it may often occur that it is not possible to perform the object detection with respect to each frame. In such cases, the term “previous frame” represents the frame previous by one between the frames for which the object detection is performed. At this time, an object, the correspondence relationship has not been detected, i.e. an object such as an object which is not detected from one of the frames due to movement over a large distance, is ignored. Only the object, the correspondence relationship has been detected, is selected and subjected to the processing described below. The total number of the selected objects is represented by I.

Thereafter, in a step S12, the distance calculating section 182 calculates a distance Li2 of the object Oi, which has been selected with respect to the current frame, from the taking lens 14. By way of example, the distance is calculated in accordance with the parallax between the right and left live view images. Thereafter, in a step S13, a judgment is made as to whether or not there was an object, the correspondence relationship of which could be detected with respect to the previous frame. In cases where it has been judged that there was the object, the correspondence relationship of which could be detected with respect to the previous frame, in a step S14, the movement distance calculating section 183 calculates a difference Mi=Li2−Li1 between the distance Li2 of the object Oi at the stage of the current frame and the distance Li1 of the object Oi at the stage of the previous frame. Specifically, the difference Mi represents the distance over which the object Oi has moved in the direction, in which the distance from the taking lens 14 alters, between the stage of the previous frame and the stage of the current frame.

Thereafter, in a step S15, the processing is performed for updating the distance Li2 at the stage of the current frame as the distance Li1 at the stage of the previous frame. Thereafter, in a step S16, a judgment is made as to whether or not i=I. In cases where it has been judged that i≠I, in a step S23, the value of i is increased by “1.” Thereafter, the processing in the step S11 and those that follow is iterated. In cases where it has been judged in the step S16 that i=I, in a step S17, a predicted lens focusing position Pi for focusing on the object Oi is calculated in accordance with the movement distances Mi of an object of the highest priority degree and an object of the second highest priority degree. Specifically, it is assumed that the object Oi continues the movement with a change rate identical with the inter-frame movement distance Mi, and the distance of the movement occurring during a period of time between the stage, at which a regular photographing operation is thereafter performed, and the stage, at which release arises, is predicted. The predicted lens focusing position Pi is calculated in accordance with the thus predicted distance and the distance Li2 at the stage of the current frame.

In cases where it has been judged in the step S13 that there was not the object, the correspondence relationship of which could be detected with respect to the previous frame, the processing in the step S14 is omitted, and the processing in the step S15 is then performed.

When the processing in the step S17 has been finished, in a step S18, a judgment is made as to whether or not the regular photographing operation has been performed, i.e. as to whether or not the shutter button 18 has been pressed fully. In cases where it has been judged that the regular photographing operation has not been performed, the processing flow is returned to the step S1, and the processing in the step S1 and in the steps that follow is performed in the same manner as that described above.

In cases where it has been judged that the regular photographing operation has been performed, in a step S19, one of the focus lenses, i.e. the focus lens 130F of the left imaging system 10L, is set at the predicted lens focusing position Pi, which has been calculated in the manner described above with respect to the object O of the highest priority degree. Also, in a step S20, the other focus lens, i.e. the focus lens 130F of the right imaging system 10R, is set at the predicted lens focusing position Pi, which has been calculated in the manner described above with respect to the object O of the second highest priority degree. Thereafter, in a step S21, exposure correction is performed. Further, in a step S22, compound eye regular photographing processing for performing the photographing operation with both the left imaging system 10L and the right imaging system 10R is performed. The photographing operation is thus finished.

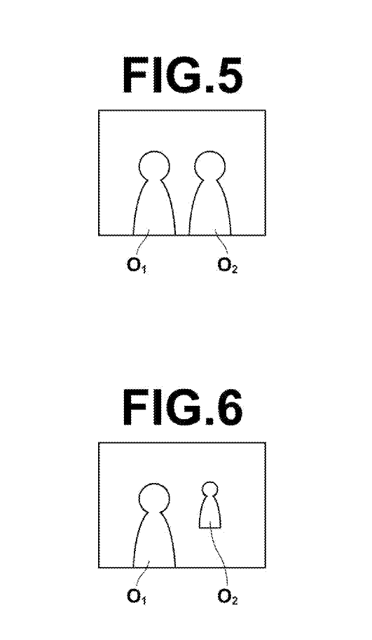

In cases where the compound eye photographing operation is performed by setting the focus lens 130F of the left imaging system 10L and the focus lens 130F of the right imaging system 10R respectively at the positions described above, the image focused on the object O of the highest priority degree is photographed by the left imaging system 10L, and the image focused on the object O of the second highest priority degree is photographed by the right imaging system 10R. Also, since the focusing processing is performed in accordance with the predicted lens focusing position Pi as described above, in cases where the object O of the highest priority degree and the object O of the second priority degree are moving in different directions or at different speeds, the focusing is performed accurately in anticipation of the object movements. Specifically, for example, at the stage of the beginning of the photographing operation, an object O₁ of the highest priority and an object O₂ of the second highest priority, which objects are moving respectively, may be located in a state as illustrated in FIG. 5. Also, at the stage immediately before the timing of moment of the compound eye photographing operation, the object O₁ of the highest priority and the object O₂ of the second highest priority may come into a state as illustrated in FIG. 6. In such cases, the image focused on the object O₁ of the highest priority and the image focused on the object O₂ of the second highest priority are photographed.

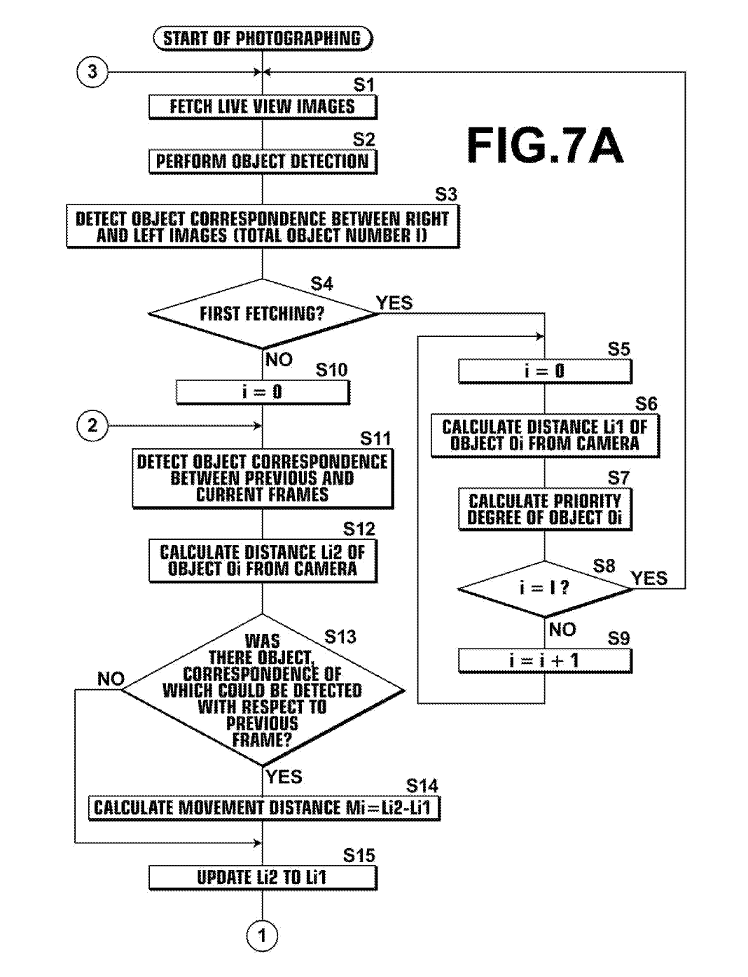

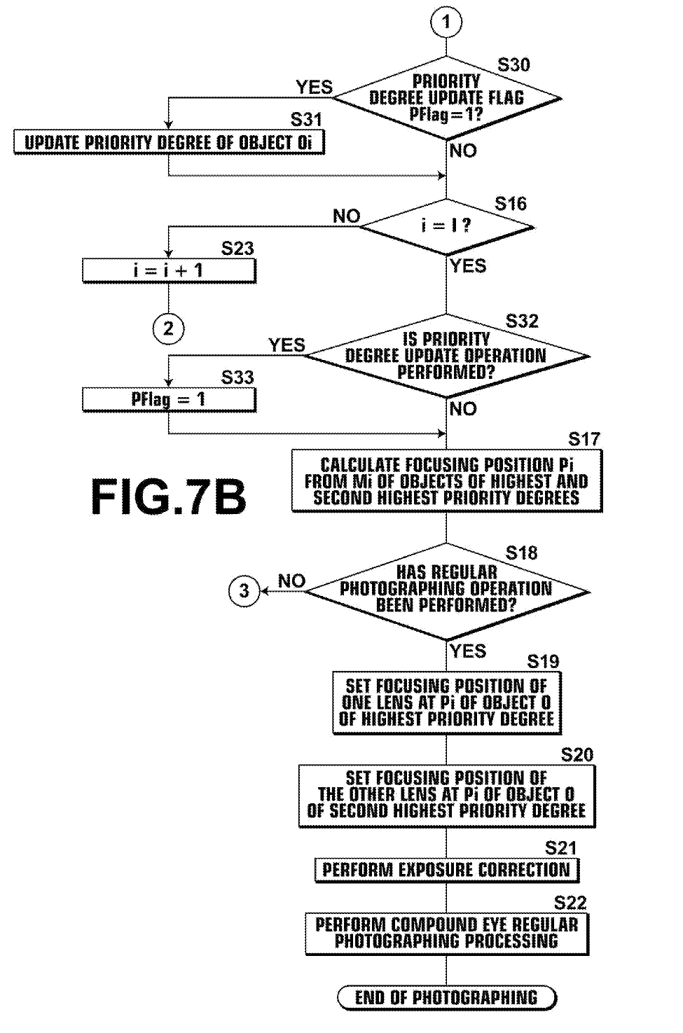

A flow of processing in a second embodiment of the compound eye photographing method in accordance with the present invention will be described hereinbelow with reference to FIGS. 7A and 7B. In FIGS. 7A and 7B, similar steps are numbered with the same reference numerals with respect to FIGS. 4A and 4B. As for FIGS. 7A and 7B (and those that follow), if it is not necessary particularly, the explanation of the similar steps will be omitted.

The method illustrated in FIGS. 7A and 7B is basically identical with the method illustrated in FIGS. 4A and 4B, except that a step S30 and a step S31 are performed between the step S15 and the step S16, and except that a step S32 and a step S33 are performed between the step S16 and the step S17. Specifically, in this embodiment, in the step S32, a priority degree update operation is performed, for example, by specifying the image of the specific object Oi on the monitor 24 constituted of a touch panel with finger touching. In cases where the priority degree update operation is performed, in the step S33, a priority degree update flag PFlag with respect to the specific object Oi is turned on.

Thereafter, in cases where the regular photographing operation is not performed immediately, the processing flow is returned to the step S1. Therefore, in the step S30, a judgment is made as to whether or not the priority degree update flag PFlag is in the on state. In cases where it has been judged that the priority degree update flag PFlag is in the on state, in the step S31, the processing is performed for altering the priority degree of the specified object Oi to the highest degree. In cases where it has been judged that the priority degree update flag PFlag is not in the on state, the priority degree update processing is not performed, and the processing in the step S16 and in those that follow is performed.

In cases where the aforesaid priority degree update processing is performed, the object O of the highest priority degree, which object is discriminated in the step S19, is set as the aforesaid specified object Oi. Therefore, in the left imaging system 10L, the photographing operation is performed by reliably focusing on the object Oi. Accordingly, in cases where an object, which the user did not intended originally, is taken as the focusing target by the calculation of the priority degree in the step S7, the user may confirm the focusing target, e.g. by the display on the monitor 24 and may then perform the priority degree update processing. Thereafter, the object intended by the user is taken as the focusing target.

Also, in this embodiment, in cases where the priority degree update operation is performed immediately before any timing of moment prior to the step S18 in which the regular photographing operation is detected, the priority degree is updated. Therefore, the user may update the priority degree with a desired timing.

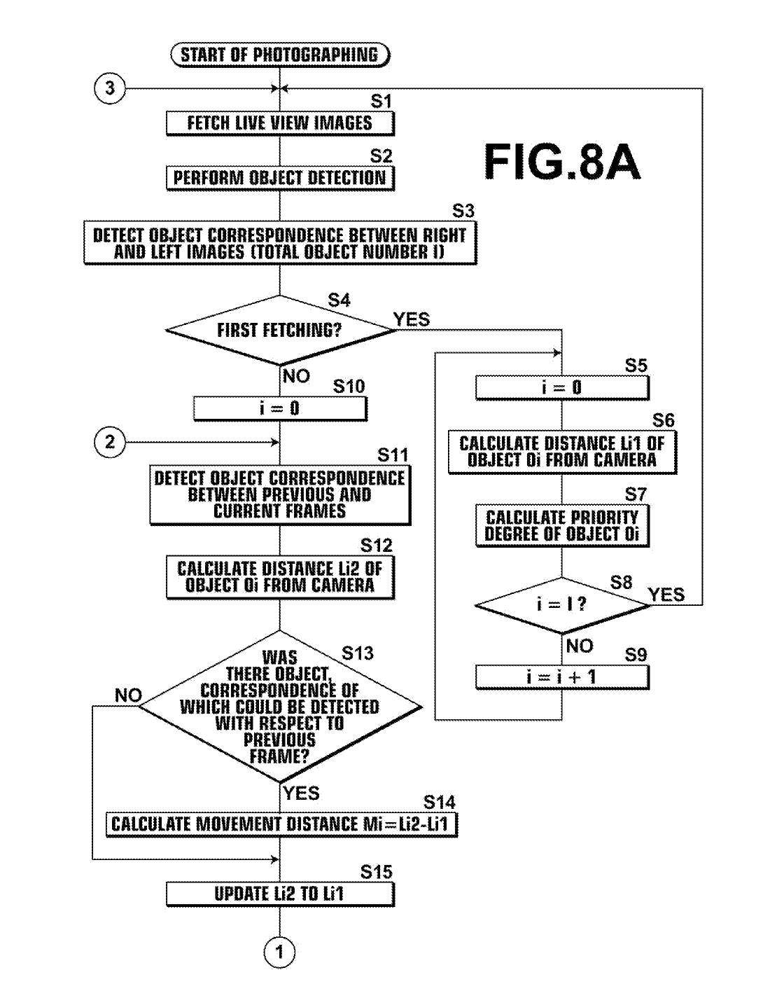

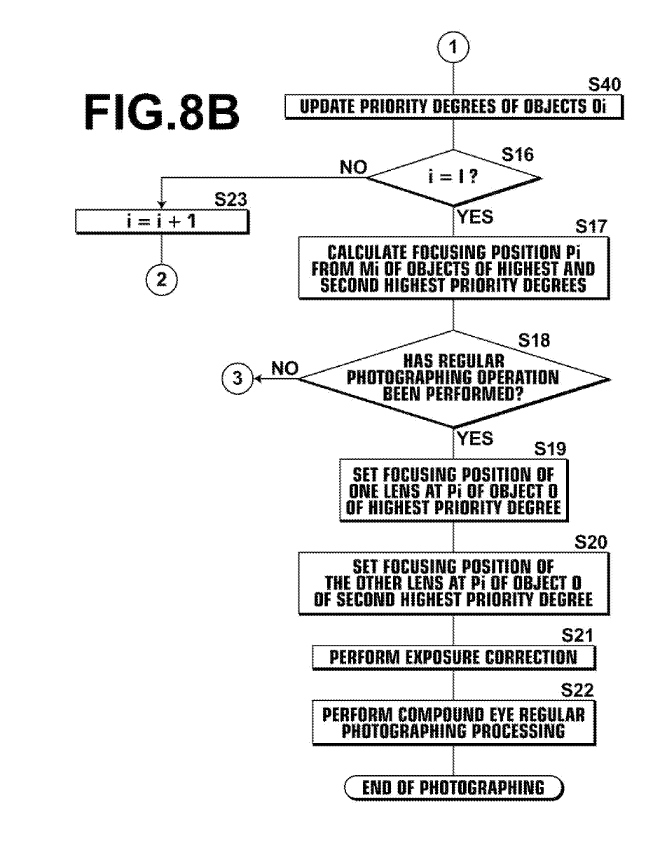

A flow of processing in a third embodiment of the compound eye photographing method in accordance with the present invention will be described hereinbelow with reference to FIGS. 8A and 8B. The method illustrated in FIGS. 8A and 8B is basically identical with the method illustrated in FIGS. 4A and 4B, except that a step S40 is performed between the step S15 and the step S16. Specifically, in this embodiment, in lieu of the priority degree being updated by the operation performed by the user as in the method illustrated in FIGS. 7A and 7B, in the step 40, the priority degrees with respect to a plurality of the objects Oi are updated automatically at the time of every variation of the frame of the live view images.

In cases where the same objects are imaged successively in the live view images, if the same objects are moving, the composition in each frame will vary, and therefore there will be the possibility that the priority degrees having already been adjusted will not be adapted to the composition of the current frame. However, in cases where the priority degrees with respect to the plurality of the objects Oi are updated automatically at the time of every variation of the frame of the live view images as in this embodiment, the photographing operation is performed by reliably focusing on the two objects which are most adapted to the priority degree adjusting conditions. Also, in cases where the original priority degree calculations have been made by mistake, the priority degree update processing may be performed, and the correct priority degrees are thus assigned to the objects.

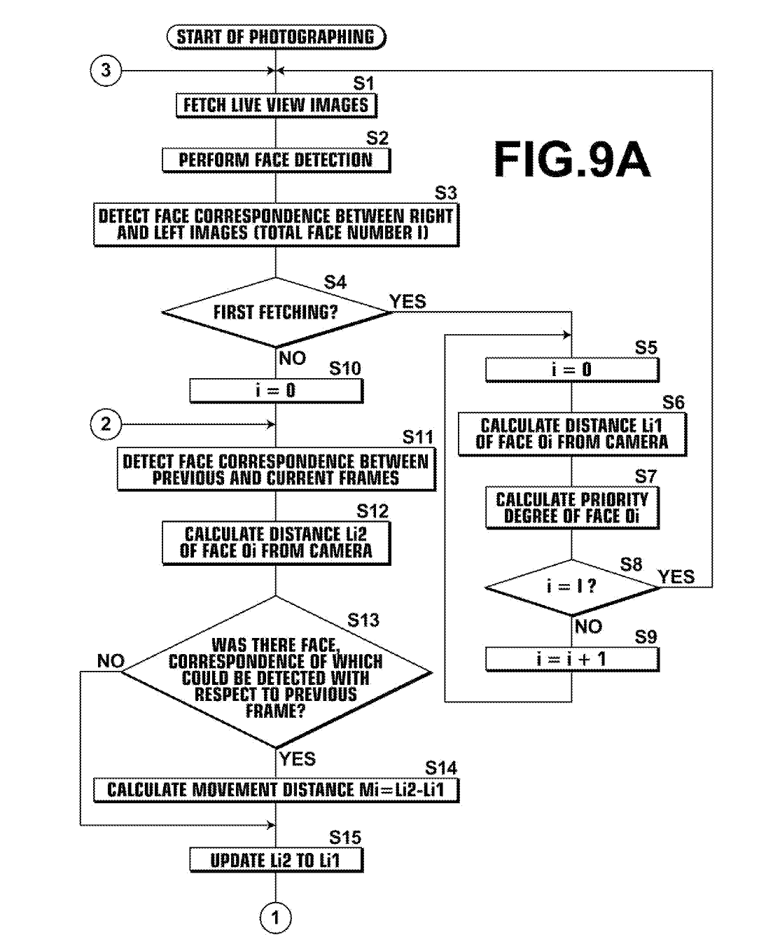

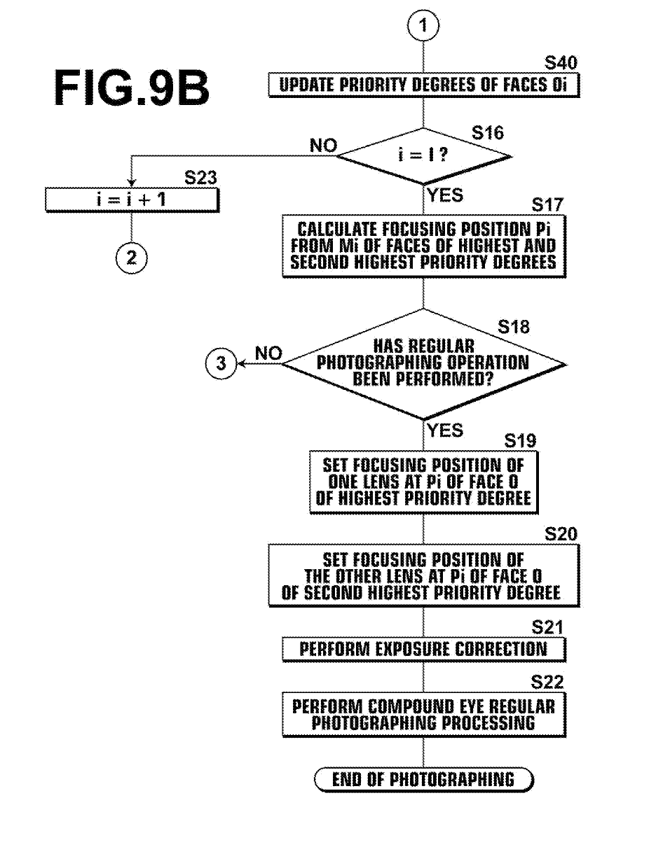

A flow of processing in a fourth embodiment of the compound eye photographing method in accordance with the present invention will be described hereinbelow with reference to FIGS. 9A and 9B. The method illustrated in FIGS. 9A and 9B is basically identical with the method illustrated in FIGS. 8A and 8B, except that the object on which the automatic focusing is to be performed is limited to a face of a person. In order for the object to be limited to the face of a person, only a face image may be extracted by the utilization of a known face image detecting technique at the time of the object detection performed in the step S2, and the face represented by the thus extracted face image may be taken as the detected object. In cases where the object is thus limited to the face of a person, the aforesaid mode dial 22 may be designed so as to enable the setting of a “face tracking” mode, or the like.

In cases where the object is thus limited to a specific kind of an object, the amount of the processing becomes small, and the focusing processing is performed quickly. Also, focusing on an object, which the user does not desire to photograph, is prevented with a high probability.

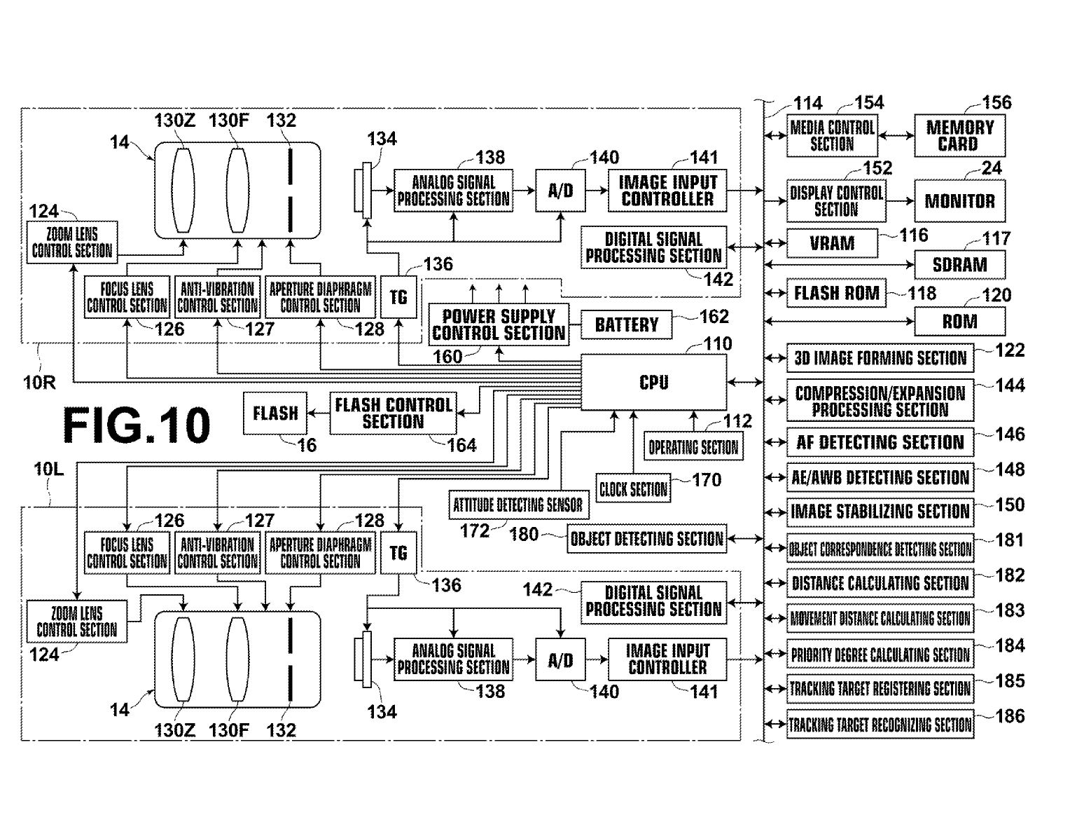

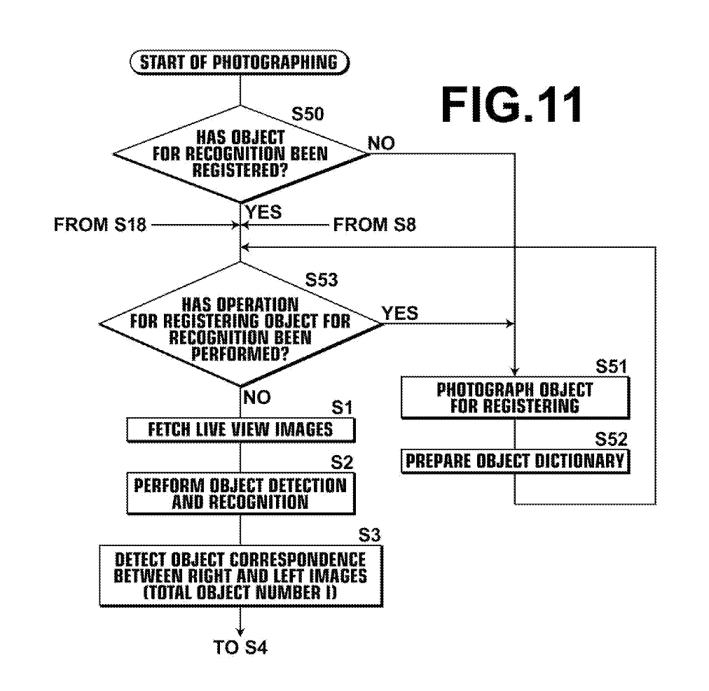

A fifth embodiment of the compound eye photographing method in accordance with the present invention will be described hereinbelow with reference to FIG. 10 and FIG. 11. FIG. 10 is a block diagram showing electric constitution of a digital camera, which is a different embodiment of the compound eye photographing apparatus in accordance with the present invention. FIG. 11 is a flow chart showing a flow of a part of processing in a fifth embodiment of the compound eye photographing method in the digital camera of FIG. 10. The constitution illustrated in FIG. 10 is basically identical with the constitution illustrated in FIG. 3, except that a tracking target registering section 185 and a tracking target recognizing section 186 are provided. The tracking target registering section 185 and the tracking target recognizing section 186 are connected via the bus 114 to the CPU 110.

The processing relevant to the tracking target registering section 185 and the tracking target recognizing section 186 will be described hereinbelow with reference to FIG. 11. In the fifth embodiment of the compound eye photographing method in accordance with the present invention, the focusing processing in the step S3 illustrated in FIG. 11 and in those that follow is performed in the same manner as that in the first embodiment illustrated in FIGS. 4A and 4B. Therefore, in FIG. 11, steps up to the step S3 are illustrated, and the step S4 and those that follow are not shown.

In the fifth embodiment, when the photographing operation is begun, firstly, in a step S50, a judgment is made as to whether an object for recognition has or has not been registered. In cases where it has been judged that the object for recognition has not been registered, in a step S51, an object for registering is photographed. Specifically, for example, a warning sound is made, a message such as that representing “Please photograph an object for registering” is displayed on the monitor 24, and the user urged by the message photograph the object for registering. In a step S52, the thus photographed object, such as the face of a specific person, is registered in a dictionary, and an object dictionary is prepared. The dictionary is registered in the tracking target registering section 185 illustrated in FIG. 10.

After the dictionary has been prepared, in a step S53, a judgment is made as to whether an operation for registering an object for recognition has or has not been performed by the user. In cases where it has been judged that the operation for registering an object for recognition has been performed, the processing in the step S51 and the step S52 is iterated, and a second object is registered in the object dictionary. In cases where the operation for registering an object for recognition is performed thereafter by the user, the object having been registered in the dictionary at the oldest stage may be deleted, and the new object may be registered in the dictionary. Alternatively, the objects having been registered in the dictionary may be displayed on the monitor 24, and an object selected by the user from the aforesaid objects may be deleted.

In cases where it has been judged in the step S53 that the operation for registering an object for recognition has been performed, in the step S1, the live view images are fetched as in the embodiments described above. Thereafter, in the step S2, the object detection from the live view images is performed. At this time, firstly, investigation is made as to whether an object having been registered in the tracking object registering section 185 is or is not detected from the live view images. The recognition of the object having been registered is performed by the tracking target recognizing section 186 illustrated in FIG. 10. At this time, in cases where one or two objects having been registered are recognized, the thus recognized objects are taken as the detected objects. In cases where nothing is recognized as the object having been registered, the object detection is performed in the same manner as that in the embodiments described above.

With the fifth embodiment, wherein the object having been registered previously is set as the tracking target, in cases where many objects, such as persons, are detected from the live view images, the unnecessary object is eliminated, and the photographing operation is performed by focusing on the objects, which the use desires to photograph. Also, by the elimination of the unnecessary object, the amount of the processing becomes small, and the focusing processing is performed quickly.

Particularly, with the fifth embodiment, wherein the object having been inputted by the user is registered in the dictionary, the probability that the photographing operation will be performed by focusing on the objects, which the use desires to photograph, is enhanced.

Three or more objects for recognition may be registered. In such cases, it is not always possible to perform the photographing operation by reliably focusing on the registered objects for recognition. However, the level of probability that at least the objects for recognition will be detected in the step S2 becomes high, and therefore the possibility that the photographing operation will be performed in the state focused on the registered objects for recognition becomes high.

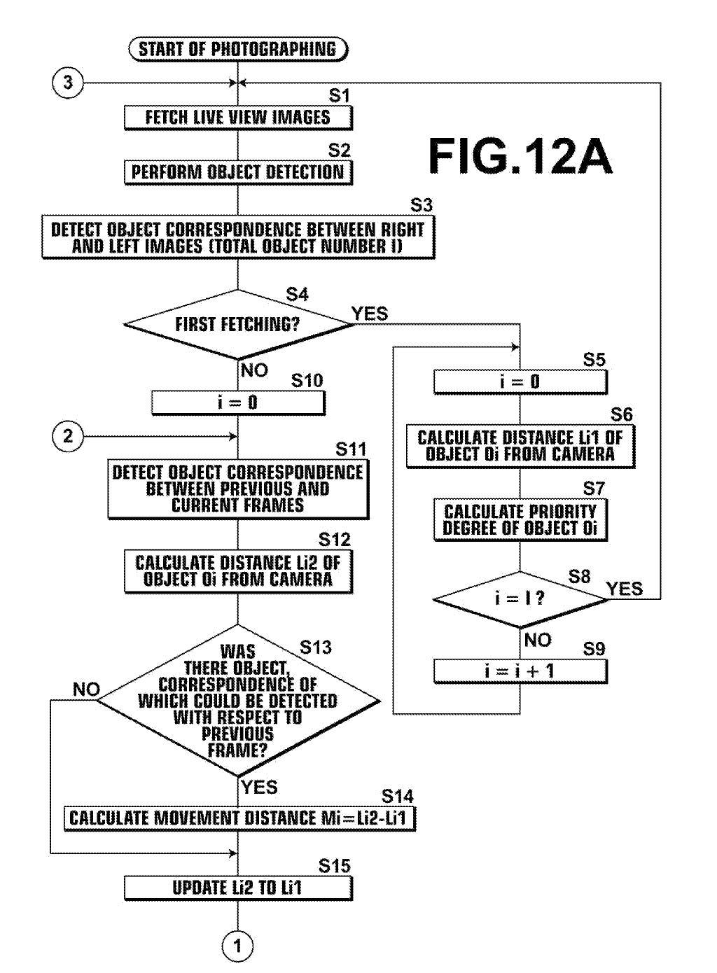

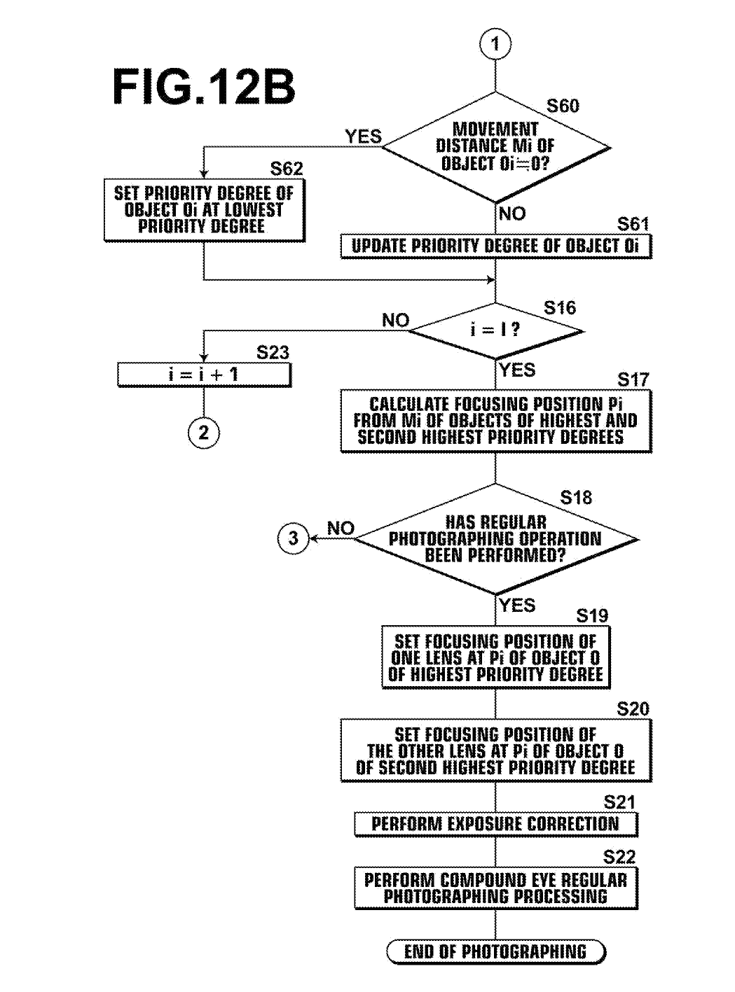

A flow of processing in a sixth embodiment of the compound eye photographing method in accordance with the present invention will be described hereinbelow with reference to FIGS. 12A and 12B. The method illustrated in FIGS. 12A and 12B is basically identical with the method illustrated in FIGS. 4A and 4B, except that a step S60, a step S61, and a step S62 are performed between the step S15 and the step S16. Specifically, in the sixth embodiment, in the step S60, a judgment is made as to whether the movement distance Mi of the object Oi is or is not approximately equal to 0 (zero). In cases where it has been judged that the movement distance Mi of the object Oi is not approximately equal to 0 (zero), i.e. in cases where it is considered that the object Oi is moving, in the step S61, the processing for updating the priority degree of the object Oi is performed appropriately as in the processing illustrated in FIGS. 8A and 8B.

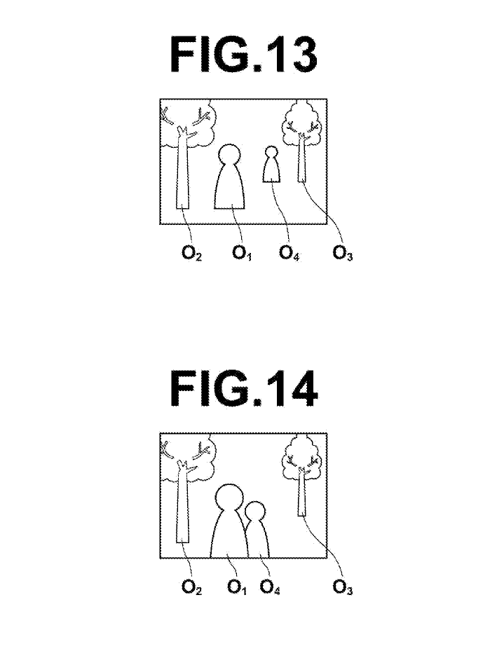

In cases where it has been judged in the step S60 that the movement distance Mi of the object Oi is approximately equal to 0 (zero), in the step S62, processing for setting the priority degree of the object Oi at the lowest priority degree is performed. Examples of the objects Oi, the movement distances Mi of which are approximately equal to 0 (zero), include trees as illustrated as objects O₂ and O₃ in FIG. 13 and FIG. 14. In the example illustrated in FIG. 13 and FIG. 14, in cases where the state illustrated in FIG. 13 changes to the state illustrated in FIG. 14 with the passage of time, persons indicated as objects O₁ and O₄ move, and the objects O₂ and O₃, which are the trees, do not move. In cases where the priority degrees of the objects, which do not move, are set at the lowest priority degrees, the focusing on the objects, which do not move, is avoided. Therefore, the probability that the photographing operation will be performed in the state focused on the objects, such as persons, on which the focusing is to be performed, becomes high.

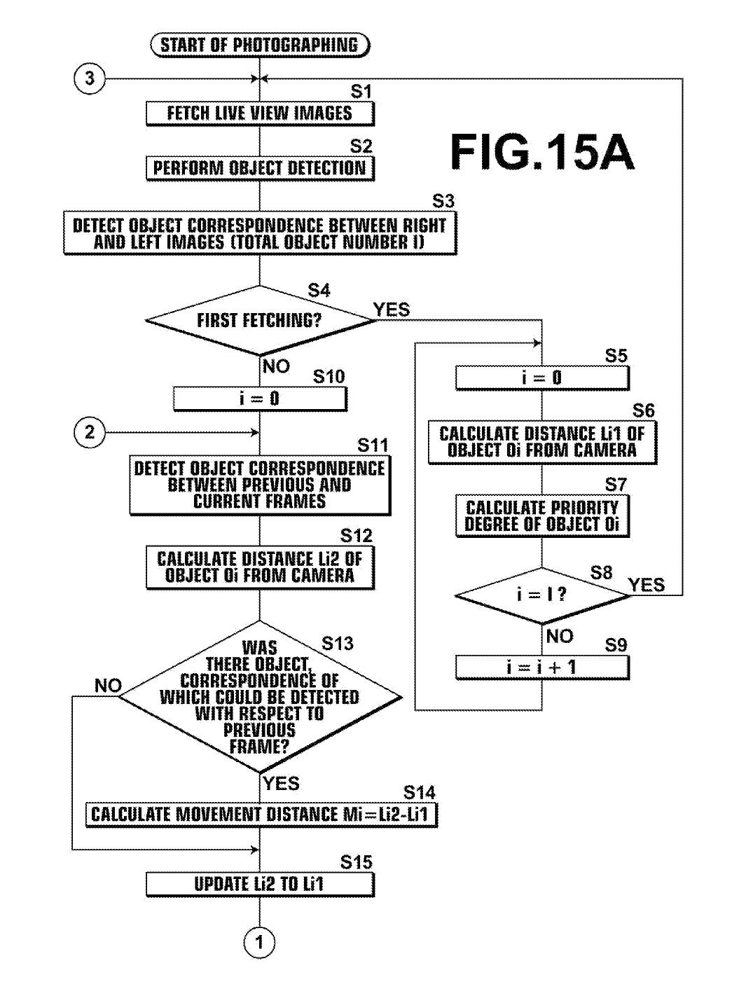

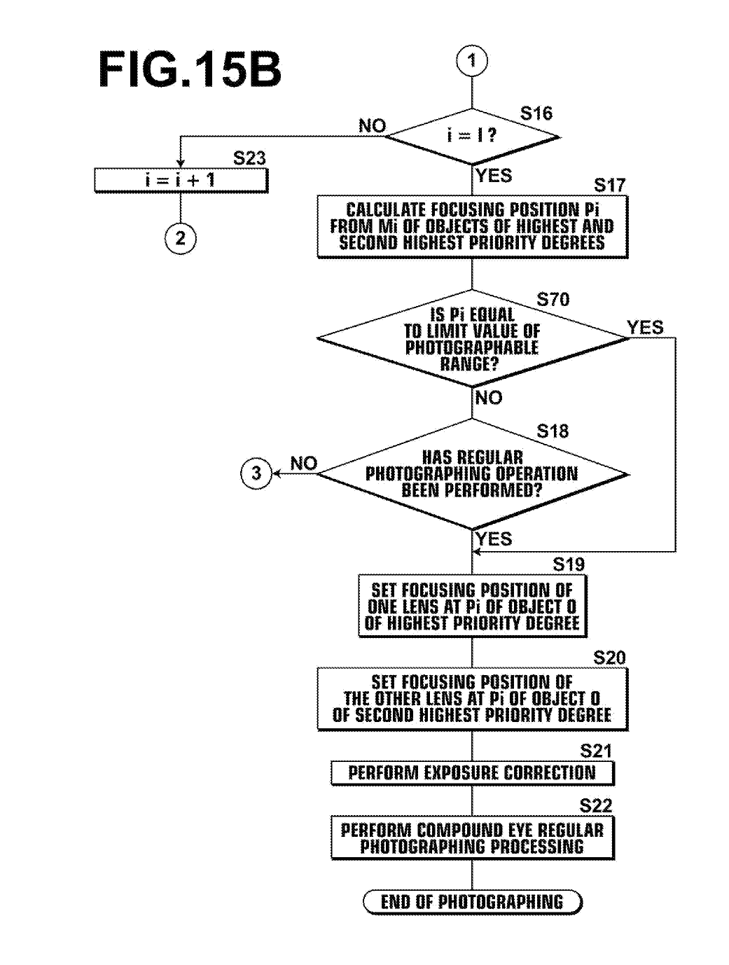

A flow of processing in a seventh embodiment of the compound eye photographing method in accordance with the present invention will be described hereinbelow with reference to FIGS. 15A and 15B. The method illustrated in FIGS. 15A and 15B is basically identical with the method illustrated in FIGS. 4A and 4B, except that a step S70 is performed between the step S17 and the step S18. Specifically, in the seventh embodiment, in the step S70, a judgment is made as to whether the predicted focusing position Pi having been calculated with respect to the object Oi is or is not equal to the limit value of the photographable range in the next frame. By way of example, the limit value of the photographable range in the next frame may be the limit value in the lens optical axis direction such that, if the camera is closer to the object than the limit value, the state out of focus will occur. In cases where it has been judged that the predicted focusing position Pi having been calculated with respect to the object Oi is not equal to the limit value of the photographable range in the next frame, the processing in the step S18 is performed as in the embodiments described above.

In cases where it has been judged that the predicted focusing position Pi having been calculated with respect to the object Oi is equal to the limit value of the photographable range in the next frame, the step S18 is bypassed, and the processing in the step S19 is then performed. Specifically, in this case, regardless of whether the regular photographing operation has or has not been performed, the regular photographing processing is performed forcibly. In such cases, it is possible to avoid the problems in that the regular photographing operation is not performed until the moving object goes beyond the photographable range. The photographing operation is thus performed reliably without a timing appropriate for the photographing of the moving objects being lost.

Besides the cases wherein the predicted focusing position Pi having been calculated with respect to the object Oi is equal to the limit value of the photographable range in the next frame, in cases where the predicted focusing position Pi having been calculated takes a value close to the limit value within a predetermined threshold value, the regular photographing processing may be performed forcibly.

Besides the processing for comparing the predicted focusing position Pi described above and the limit value of the photographable range with each other, a comparison may be made between the movement distance Mi having been calculated with respect to the object Oi and the limit value of the photographable range. In such cases, the limit value is taken as a limit value in a direction intersecting with the lens optical axis such that, if the movement of the object Oi continues even further, the object Oi will goes beyond an angle of view. In such cases, it is possible to avoid the problems in that the regular photographing operation is not performed until the moving object goes beyond the photographable range. The photographing operation is thus performed reliably without a timing appropriate for the photographing of the moving objects being lost.

Also, besides the forcible carrying out of the regular photographing processing as described above, a warning sound or a warning displaying for urging the regular photographing operation may be made in order to assist the user to quickly begin the regular photographing operation.

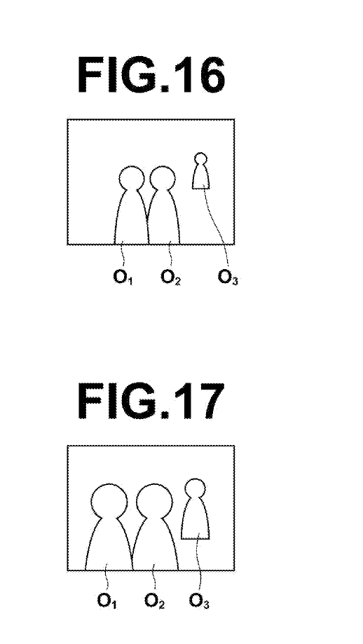

In the embodiments described above, the processing is performed by regarding till the completion of the photographing operation that each of the detected objects is an individual object. Alternatively, for example, as in the cases of the objects O₁ and O₂ illustrated in FIG. 16 and FIG. 17, a plurality of objects, the movement distances of which are equal to each other between two frames, may be processed as a single object after it has been detected that the movement distances are equal to each other. In cases where the number of the objects is thus decreased, the number of the objects taken as the target of the automatic focusing may be increased, and therefore an image may be photographed such that the focusing is performed on a large number of objects.

What is claimed is:

1. A compound eye photographing apparatus, comprising:
i) two imaging sections, each of which is provided with a focus lens,
ii) an object detecting section for detecting a predetermined object from two live view images, which are outputted respectively by the two imaging sections,
iii) an object correspondence detecting section for detecting correspondence relationship of the detected object between the two live view images and between a previous frame and a current frame of the live view images,
iv) a priority degree adjusting section for adjusting priority degrees of objects in cases where a plurality of the objects have been detected,
v) a distance calculating section for calculating a distance from a camera to the detected object,
vi) a movement distance calculating section for calculating an object movement distance between the frames of the live view images, the calculation being made in accordance with an amount of change of the camera-to-object distance, which change occurs between the frames of the live view images, and
vii) a focusing position predicting section for predicting a focusing position with respect to the object, which focusing position is to be taken for each of the next frame and frames that follow, the prediction being performed in accordance with the calculated object movement distance,
the prediction of the focusing position being performed with respect to each of an object of the highest priority degree and an object of the second highest priority degree in cases where the plurality of the objects have been detected by the object detecting section,
whereby a photographing operation is performed by focusing on each of the object of the highest priority degree and the object of the second highest priority degree at each of the two imaging sections in accordance with each of the predicted focusing positions.

2. An apparatus as defined in claim 1 wherein the apparatus receives a priority degree update operation performed by an apparatus user and performs priority degree update processing for readjusting the priority degrees of the objects.

3. An apparatus as defined in claim 1 wherein the apparatus performs priority degree update processing for readjusting the priority degrees of the objects at the time of every variation of the frame of the live view images.

4. An apparatus as defined in claim 2 wherein the apparatus performs priority degree update processing for readjusting the priority degrees of the objects at the time of every variation of the frame of the live view images.

5. An apparatus as defined in claim 1 wherein the objects acting as targets of the focusing are previously registered in registering means,
the objects having been registered in the registering means are recognized at the time of the detection of the objects in the live view images, and
the thus recognized objects having been registered in the registering means are taken as the detected objects.

6. An apparatus as defined in claim 2 wherein the objects acting as targets of the focusing are previously registered in registering means,
the objects having been registered in the registering means are recognized at the time of the detection of the objects in the live view images, and
the thus recognized objects having been registered in the registering means are taken as the detected objects.

7. An apparatus as defined in claim 3 wherein the objects acting as targets of the focusing are previously registered in registering means,
the objects having been registered in the registering means are recognized at the time of the detection of the objects in the live view images, and
the thus recognized objects having been registered in the registering means are taken as the detected objects.

8. An apparatus as defined in claim 4 wherein the objects acting as targets of the focusing are previously registered in registering means,
the objects having been registered in the registering means are recognized at the time of the detection of the objects in the live view images, and
the thus recognized objects having been registered in the registering means are taken as the detected objects.

9. An apparatus as defined in claim 5 wherein the objects inputted by a user are taken as the objects to be registered.

10. An apparatus as defined in claim 6 wherein the objects inputted by a user are taken as the objects to be registered.

11. An apparatus as defined in claim 7 wherein the objects inputted by a user are taken as the objects to be registered.

12. An apparatus as defined in claim 8 wherein the objects inputted by a user are taken as the objects to be registered.

13. An apparatus as defined in claim 1 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

14. An apparatus as defined in claim 2 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

15. An apparatus as defined in claim 3 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

16. An apparatus as defined in claim 4 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

17. An apparatus as defined in claim 5 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

18. An apparatus as defined in claim 9 wherein a judgment is made as to whether the predicted focusing position is or is not close to a limit of a photographable range, and
photographing processing is performed in cases where it has been judged that the predicted focusing position is close to the limit of the photographable range, the photographing processing being performed even though the photographing processing by a user is not performed.

19. An apparatus as defined in claim 1 wherein the object movement is detected in accordance with the calculated object movement distance, and
an object, the movement of which is not detected, is excluded from a target of the focusing.

20. A compound eye photographing method, comprising the steps of:
i) imaging two live view images by two imaging sections, each of which is provided with a focus lens,
ii) detecting a predetermined object from the two live view images, which are outputted respectively by the two imaging sections,
iii) detecting correspondence relationship of the detected object between the two live view images and between a previous frame and a current frame of the live view images,
iv) adjusting priority degrees of objects in cases where a plurality of the objects have been detected,
v) calculating a distance from a camera to the detected object,
vi) calculating an object movement distance between the frames of the live view images, the calculation being made in accordance with an amount of change of the camera-to-object distance, which change occurs between the frames of the live view images,
vii) predicting a focusing position with respect to the object, which focusing position is to be taken for each of the next frame and frames that follow, the prediction being performed in accordance with the calculated object movement distance, and
viii) performing the prediction of the focusing position with respect to each of an object of the highest priority degree and an object of the second highest priority degree in cases where the plurality of the objects have been detected,
whereby a photographing operation is performed by focusing on each of the object of the highest priority degree and the object of the second highest priority degree at each of the two imaging sections in accordance with each of the predicted focusing positions.
